(19) United States
(12) Patent Application Publication
(10) Pub. No.: US 2005/0220921 A1
(43) Pub. Date: Oct. 6, 2005

(54) Dynamic forging impact energy retention machine

(76) Inventor: Kent Olsson, Stockholm (SE)

Correspondence Address: YOUNG & THOMPSON, 745 SOUTH 23RD STREET, 2ND FLOOR, ARLINGTON, VA, 22202, US

(21) Appl. No.: 10/502,584

(22) PCT Filed: Jan. 24, 2003
(86) PCT No.: PCT/SE03/00129

§ 371 Date: May 9, 2005

(30) Foreign Application Priority Data
Jan. 25, 2002 (SE) 0200230-1
Jul. 25, 2002 (SE) 0202324-0

(51) Int. Cl. B29C 43/02

(52) U.S. Cl. 425/352; 425/411

(57) ABSTRACT

A machine for producing a body with desired shape of a workable material through dynamic forging under impact and finally with energy retention while the shock wave fades out. The machine includes a machine stand, a dynamic outer impact system having an upper unit, and a lower impact unit, which includes a counter-impact device, and possibly one or more dynamic side impact units, and a static inner press system having an upper unit and a lower unit, possibly with additional one or more static side compacting units, with a central unit in between. The lower units of the outer and inner systems can be exchanged with a common stationary anvil for a single direction machine instead of a counter-acting machine.

### TECHNICAL FIELD

The invention concerns a shock (impact) machine, performing Dynamic Forging Impact Energy Retention (DFIER), for forming a body with desired shape of a workable material through shock (impact) action in an impact step, said impact machine comprising a machine stand, a dynamic outer system and a static inner system. Two embodiments are here exemplified; First, an embodiment where action is performed without a stationary anvil, comprising an inner system, which comprises an upper press unit with a ram and a punch, a flower press unit which comprises a counter-acting ram and a punch, and an outer system, comprising an upper impact ram unit and a lower counter-acting impact ram unit, each comprising mountable weights. Second, an embodiment where action is performed with a stationary anvil, comprising an inner system, which comprises an upper press unit with a ram and a punch, and an outer system comprising an upper impact ram unit, comprising mountable weights, with, for both the inner and outer systems together, a lower stationary anvil and a lower punch. In both embodiments there is a central unit between the upper and the lower units of the inner system preferably including a vibrator system. The inner and/or the outer system can be equipped with one or more press and/or impact units creating side compaction and compression respectively of the working material. The invention also concerns a method of forming a body of workable material of such a machine.

### STATE OF THE ART

Impact machines for working by the employment of high kinetic energy are machines for working any material, such as punching, and plastic forming of powder or solid components, powder compression, and similar operations, in which the speed of a ram, which may consist of a press ram, may be essentially higher than in conventional presses. Metals, as well as polymeric and ceramic working materials can be conceived, as well as various composites of metals, polymers and ceramic materials in any combination. The working principle is based on the development of a very high kinetic energy of short duration in combination with or without a high static press force, instead of a very high kinetic energy of short duration alone, or a high static press force of long duration alone. The dynamic forces of short duration which are generated at the ram impact and which in impact machines of prior art are conveyed around in the system via a stand and foundation may be several thousand times larger than in the conventional presses and imply that considerable amounts of energy are lost in stands and foundations instead of being used for effective work in an optimal way. In order to be able to absorb large force pulses, impact machines of prior art are equipped with very strong and heavy stands and foundations according to principles which are common in connection with conventional presses. Nevertheless, the dynamic shock waves that are developed in impact machines are not damped in such heavy, conventional systems. The stress on all joints therefore become very large, as well as on sensitive components, e.g. electronic components for controlling those hydraulic valves which usually form parts of impact machines, which may cause a great risk, of failure. Large, unwieldy stands also give rise to problems in connection with service, change of tool unit or of tool inserts in the tool unit, changing the height of the impact unit above the tool unit. Furthermore, moving the machine from one site to another with a fixed foundation is very complicated and costly.

The use of an inner system increases the fraction of energy transferred to the working material due to the simultaneous static pressure, hence less energy is lost in foundations and stands.

To apply a shock energy simultaneously with a static pressure is now possible with the DFIER machine resulting in a reduced shock energy required to obtain the same density of the produced body. This is not possible with the machine principles of prior art. Furthermore, the present invention reduces the possibility of any re-bouncing of punches or machine parts occurring in the absence of an inner system as in machines of prior art. The said DFIER machine eliminates the re-bouncing phenomenon of any tool and machine parts. Re-bouncing creates cracks and results in micro-fractures of the produced body.

PCT patent WO 97/00751 disclose a percussion machine. This machine is primarily intended for cutting metal rods but it is also stated that this machine might be used for compression of metal powders. It is suggested that the machine can be used for compacting of powder in a spherical mould. Furthermore, it is claimed that it is possible to achieve compacting of spherical, gas atomised powders. It is also stated that the compression should be performed in several steps, e.g. three. And that each stroke has a specific function described as: Stroke one should be an extremely light stroke with the aim to force out most of the air from the powder, stroke two should be performed with a high-energy density and high impact velocity where it is claimed that local adiabatic coalescence is achieved between the powder particles. Stroke three should be performed with medium-high energy for which the final shaping of the compact. There are however no examples specifying parameters demonstrating the effect of such a compression or how a body is produced, except that the powder inserted can be compacted with the percussion machine to a density of 94-99% of the corresponding homogeneous material. Any slip planes, a landmark detected in adiabatic coalescence, is not possible to find in bodies produced in the WO 97/00751.

From practical tests the theoretical model described in WO 97/00751, does not work, as the body cracks and gets micro-fractures. Additionally, the example describes a process which is today physically impossible to perform and to design a working machine for.

PCT patent WO 02/38315 disclose a method for preparing and manufacturing metal components from a metal powder using a high velocity compaction operation HVC. The invention concerns compacting of preferably irregular iron based powder or iron based alloy powders mixed with optional mixtures of alloying elements or/and internal lubricants or other particular additives. It is claimed that the compaction may be performed in a lubricated die with or without admixed internal lubricants or lubricated coated particles. In the latter two alternatives it is claimed that lubrication of the moulding die may not be necessary. The disclosed compression method is referred to as said high velocity compaction, which is performed by providing energy to the powder through a punch by a single acting ram with a ram speed claimed to be above 2 m/s, and that the compact densities reach above 96% of the theoretical density for powder of irregular configuration, and that compaction can be performed with internal lubrication and with die wall lubrication respectively. However, the said HVC method refers to a single direction with a single impact (shock) ram machine configuration.

Furthermore, testing has shown that internal lubrication, as described in WO 02/38315, is not required for most materials, and that lubrication of the die wall is sufficient enough. A lubricant-free powder is preferred due to a higher density achieved as the bulk of added lubricant reduces the theoretical density. Internal lubricated powders also need additional heat treatment to burn off the internal lubricant. Additionally, reduction of additives contributes to a more friendly environment.

WO 02/38315 also elucidates the unrealistic and disputable claims stated in the said patent application WO 97/00751.

PCT Patent WO 02/22289 disclose an impact machine for forming a body with desired shape of a formable working material through only one impact action in a forming operation. The said impact machine comprising a machine stand, an upper unit which comprises an upper impact unit, a lower impact unit which comprises either a counter-impact device or a stationary anvil, and a central unit between the upper and the lower unit. The patent also discloses a method of forming a body of formable working material with such a machine. The central unit comprises one or more carriers for one or a multiple of identical tool units. The said carriers including at least one carrier which is stationary during the forming operation. A motion device can provide for indexed motion of the carrier either circular or linear for positioning the tool units in different process stations.

Our experience of different impact machine types such as disclosed in WO 02/22289 and WO 97/00751 for compacting of a material to a body, is that the produced body has included crevices, micro-cracks and micro-fractures. It is encountered during the short impact cycle, mainly because of re-bouncing and expansion. In this case, high strain and stress variations are induced during the impact, and the sudden release of the shock load, which results in a minor explosion due to built-up of residual stress and strain. Furthermore, to obtain material body densities close to the theoretical density of many metal, ceramic and polymer materials, these machines require high shock, stroke or impact energies resulting in short tool life span and high tool costs, due to load exhaustion and short-term fatigue.

The tool carrier system including a multiple of identical tools for manufacturing of a component suggested in the machine described in patent WO 02/22289, is assumed to be practically economically impossible due to high tool costs. Additionally, WO 02/22289 talks about only one impact, which gives a clear indication that the machine is derived from a cutting machine not taking forming in account.

Another problem with known impact machines of the aforesaid type is that they have a comparatively small production capacity. This is basically due to the clumsiness of the machines, which makes it difficult to provide the machine with devices which would make a rational production possible.

In SE 9803956-3 a method and a device for deformation of a material body are described. This is substantially a development of the invention described in WO-A1-9700751. In the method according to SE 9803956-3, the striking unit is brought to the material by such a velocity that at least one rebounding motion of the striking unit is generated, the rebounding being counteracted whereby at least one further stroke of the striking unit is generated.

The strokes according to the method described in WO-A1-9700751, give a locally very high temperature increase in the material, which can lead to phase changes in the material during the heating or cooling. When using according to SE 9803956-3 a counter-acting of the rebounding motion generating at least one further stroke, this stroke contributes to the wave going back and forth and being generated by the kinetic energy of the first stroke, continuing during a longer period. This leads to further deformation of the material and with a lower impulse than would have been necessary without the counteracting.

It has now been found that the machine according to these documents does not work so well. For example, the time intervals between the strokes, which they mention, are not possible to attain. Further, the documents do not comprise any embodiments showing that a body can be formed. Also, the rebounding strokes have proved to result in cracking of the material.

PCT/SE01/01670 describes a method of producing a metal body by coalescence, wherein the method comprises the steps of a) filling a pre-compacting moulding die with metal material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material.

A method of producing a metal body by coalescence, wherein the method comprises compressing material in the form of a solid metal body in a compression mould by at least one stroke, where a striking unit emits enough energy to cause coalescence of the material in the body.

PCT/SE01/01671 describes a method of producing a polymer body by coalescence, wherein the method comprises the steps of a) filling a pre-compacting mould with polymer material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material.

A method of producing a polymer body by coalescence, wherein the method comprises compressing material in the form of a solid polymer body in a compression mould by at least one stroke, where a striking unit emits enough energy to cause coalescence of the material in the body.

PCT/SE01/01672 describes a method of producing a multilayer body by coalescence, characterised in that the method comprises the steps of a) filling a pre-compacting mould with a start material in the form of powder, pellets, grains and the like, b) pre-compacting the start material at least once and c) compressing the material in a compression mould by at least one stroke, where a striking unit emits enough kinetic energy to form the body when striking the material inserted in the compression mould, causing coalescence of the material, d) at least one further material being inserted into the mould in the form of powder, pellets, grains and the like, either in step a), after compacting in step b) or after compressing the first material in step c), e) if necessary, further pre-compacting and/or compressing being performed after the insertion of the at least one further material.

A method of producing a multilayer body by coalescence, wherein the method comprises compressing material in the form of a solid multilayer body in a compression mould by at least one stroke, where a striking unit emits enough energy to cause coalescence of the material in the body, a second material being inserted in the mould either in the form of powder, pellets, grains and the like or in the form of a solid body, the second material also being struck by the striking unit, either in the first stroke or in a later stroke where the two materials form an integral body.

PCT/SE01/01673 describes a method of producing a ceramic body by coalescence, wherein the method comprises the steps of a) filling a pre-compacting mould with ceramic material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material.

A method of producing a ceramic body by coalescence, wherein the method comprises compressing material in the form of a solid ceramic body in a compression mould by at least one stroke, where a striking unit emits enough energy to cause coalescence of the material in the body.

PCT/SE01/01674 describes a method of producing a composite body by coalescence, wherein the method comprises the steps of a) filling a pre-compacting mould with composite material in the form of powder, pellets, grains and the like, b) pre-compacting the material at least once and c) compressing the material in a compression mould by at least one stroke, where a striking unit emits enough kinetic energy to form the body when striking the material inserted in the compression mould, causing coalescence of the material.

A method of producing a composite body by coalescence, wherein the method comprises compressing material in the form of a solid composite body in a compression mould by at least one stroke, where a striking unit emits enough energy to cause coalescence of the material in the body.

Products obtained by the described inventive methods in PCT/SE01/01670, PCT/SE01/01671, PCT/SE01/01672, PCT/SE01/016730, PCT/SE01/01674, are referred to as the foundation to build a shocking machine on. The methods are alone to describe the effects on different material types and how to handle the forces involved with the materials processed to avoid cracking, micro-fractures, overloaded strain and stress fractures of the produced body. The invention of a dynamic forging impact energy retention machine takes these methods in account and refers to it.

SE-0200230-1 describes a process for producing a body from particulate material by coalescence or compression to higher density by the steps of a) filling a mould die with the material in the form of powder, pellets, grains or the like, b) vibrating the mould, c) pre-compacting the material at least once with a pre-compacting means and d) compressing the material in a compression mould by at least one stroke, where a striking unit emits enough kinetic energy to form the body when striking the material inserted in the compression mould with a striking means, causing coalescence or higher density of the material.

A method of producing a body from solid material by the steps of a) inserting the solid material in a mould, c) possibly pre-compacting the material at least once with a pre-compacting means and d) compressing the material in the mould by at least one stroke, from two sides simultaneously, using two striking units emitting enough kinetic energy to form the body when striking the material, causing coalescence or higher density of the material.

A body produced by the method described in SE-0200230-1 is referred to in this invention of a dynamic forging impact energy retention machine. It overcomes the pitfalls described of what other impact machines can achieve.

### OBJECT OF THE INVENTION

The object of the present invention is to design an impact machine which achieves a low cost process for efficient production of bodies from a particulate material or a solid material by coalescence or compaction to a higher density.

Another object is to achieve a design of the machine for optimised production of material bodies to a higher density and to reduce the required shock energy with the objective to reduce the loading of machine and tool parts. And, also to manufacture components of better material properties and higher quality. Furthermore, the aim is to design the machine so that it can easily be adapted to manufacture a wide range of different component sizes, shapes and material types.

### SHORT DESCRIPTION OF THE INVENTION

The invention concerns a machine for compression and compaction of a working material into a desired shape. The working material is for example in the form of powder, pellets, grains and the like and is filled in a moulding die cavity, compacted to a body of higher density. The material may also be in solid form.

The machine comprises an outer system and an inner system. The outer system comprises at least one or more impact units, an upper and/or lower, each comprising an impact ram. The inner system comprises at least one or more static press units, each comprising a press ram and a punch, and a central unit, preferably comprising a vibrator unit, and a tool unit. The lower units of the inner and outer systems, can be exchanged for a common stationary anvil and a lower punch. The tool unit comprises a moulding die mounted in a moulding die table or carrier, movable and attached to the central unit, an upper punch removably attached to the upper press unit and a lower punch removably attached to the lower press unit or the stationary anvil. The central system comprises a movable moulding die carrier, which holds a moulding die. The said moulding die carrier has at least two or more function stations. A processing and a service station. At the processing station, the moulding die is positioned concentrically with the upper and lower punches.

The main function steps of the machine are defined as lubrication, filing of working material, pre-compaction, compression, retention and ejection, which all are performed with the moulding die positioned in the processing station.

Lubrication with a thin film of the moulding die walls is automatically applied.

Filling of working material is performed by raising the lower press ram or lower the centering unit to a position so that the lower punch is inserted in the moulding die's through hole and together creating a moulding die cavity. The powder is then filled by any automated means.

In the pre-compaction step the powder is compacted by a simultaneous static pressure, vibration, gas evacuation or injection, temperature control and electrical discharge by all or by any combination. The static pressure during pre-compaction is achieved by using the inner system. The vibration is performed by vibrating the inner system.

The compression step with the DFIER machine is performed by keeping the static pressure on the inner system and hence the working material simultaneously with a generation of an impact by accelerating the impact ram(s) at least one or more times. The shock wave is created and transferred to the working material through the press ram(s) and the punches while the pressure from the press ram(s) is kept unchanged. The impact unit(s) delivers enough kinetic energy to form the material into a body when striking the material, causing coalescence or higher density of the material.

Controlling the delivered shock energy is performed by the exact knowledge of the acceleration distance to the press ram(s). The impact ram is immediately retracted after the shock, while the static press still is kept in position.

After the compression step of the material body the DFIER machine retains the static pressure by the inner inner system until the shock wave has faded out. This will relax the material and prevent initiation of cracks or micro-fractures occurring in the material body during or before ejection.

Ejection of the material body produced with the DFIER machine is performed by keeping the static pressure on the material body by the inner system. Ejection is performed by an axial movement of the upper and lower press rams or by the a axial movement of the central unit.

The use of hydraulic ram actuation seems today to give the best sequence control and the lowest running costs, compared to the use of compressed air, spring-actuation or electrical actuation. However, the machine design is not limited for using a hydraulic system as the driving system.

### DISCLOSURE OF THE INVENTION

The invention concerns a machine utilising a method of producing a body. Further aspects on this method are disclosed in the patent application SE-0200230-1, the content of which is herewith included in the present patent application by reference. However, the machine is not limited for using the method described in SE-0200230-1.

The invention also concerns the product obtained by the methods described above.

It is a first purpose of the invention to address and to solve the mentioned problem, i.e. to provide a machine which allows rational manufacturing of bodies with desired shape from a workable material, without cracking and getting micro-fractures.

The working material may consist of e.g. a powder or one or more completely or not completely solid or porous agents of in the first place metal or possibly polymeric or ceramic material or of various composites of metallic, polymeric, or ceramic materials.

To get improved relative density it is also possible to pre-process the material before the process. The powder could be pre-heated to e.g. ˜50-300 degrees C. or higher depending on what material type to pre-heat. Suitable ways of pre-heating may be used, such as normal heating of the powder in an oven. In order to get a more dense material during the pre-compacting step vacuum or inert gas could be used. This would have the effect that air is not enclosed in the material to the same extent during the process.

The working material may comprise a lubricant and/or a sintering aid.

A lubricant may be useful to mix with the material. Sometimes the material needs a lubricant in the mould, in order to easily remove the body. In certain cases this could be a choice if a lubricant is used in the material, since this also makes it easier to remove the body from the mould, A lubricant cools, takes up space and lubricates the material particles. This is both negative and positive.

Interior lubrication is good, because the particles will then slip in place more easily and thereby compact the body to a higher degree. It is good for pure compaction. Interior lubrication decreases the friction between the particles, thereby emitting less energy, and the result is less inter-particular melting. It is not good for compression to achieve a high density, and the lubricant must be removed for example with sintering.

In some cases it may be necessary to use a lubricant in the mould in order to remove the body easily. It is also possible to use a coating in the mould. The coating may be made of for example TiNAl or Balinit Hardlube. If the tool has an optimal coating no material will stick to the tool parts and consume part of the delivered energy, which increase the energy delivered to the powder. No time-consuming lubricating would be necessary in cases where it is difficult to remove the formed body.

Polishing and cleaning of the tool may be avoided if the tool is lubricated and if the powder is pre-heated.

The preferred method of producing a body from particulate material could be described in the following way.

Powder is pressed to a green body with concomitant vibration, the body is compressed by impact to a (semi)solid body and thereafter an energy retention may be achieved in the body by a post-compacting. The process, which could be described as Dynamic Forging Impact Energy Retention (DFIER) involves three mains steps.

A) Pre-Compaction Step

The pressing step is very much like cold and hot pressing. The intention is to get a green body from powder. It has proved most beneficial to perform two compactions of the powder, with a small interval of for example about 5 seconds. A varied pressure may be used in the second pre-compacting. One compaction alone gives about 2-3% lower density than two consecutive compactions of the powder. A continuous compaction throughout the pressing step gives even better densities. This step is the preparation of the powder by evacuation of the air and orientation of the powder particles in a beneficial way. The density values of the green body is more or less the same as for normal cold and hot pressuring. It is beneficial to vibrate the working material together with the mould to get even better densities of the final body.

B) Impact Step

The impact step is the actual high-speed step, where an impact unit shocks the powder with a defined area. A shock wave starts off in the powder and inter-particular melting takes place between the powder particles. Velocity of the striking unit seems to have an important role only during a very short time initially. The mass of the powder and the properties of the material decides the extent of the inter-particular melting taking place.

C) Energy Retention Step

The energy retention step aims at keeping the delivered energy inside the solid body produced. It is physically a compaction with at least the same pressure as the pre-compaction of the powder. The result is an increase of the density of the produced body by about 1-2%. It is performed by for instance letting the inner system stay in place on the solid body after the impact and press with at least the same pressure as at pre-compaction, or release after the impact step. It gives more transformations of the powder in the produced body.

Heating and electrical discharge of the tool system provides additional energy to the said working material, reducing the said shock energy magnitude to reach the said material plasticity and flow, which will increase tool life span and widens the process window. The said function stations also comprise a retention step generated by said inner system, which performs a pressurised retention step where the said body is contained in the moulding die cavity under equal, incremental or decremental static pressure. The said indexed function stations include at least one more function station which may be a station for said moulding die service and change. In full production, a jukebox can with the help of a robot automatically exchange different tools for production of different components.

The body may according to another embodiment of the invention be heated and/or sintered any time after compression or post-compacting.

The described method is fully implemented in the invention of the machine.

According to a first embodiment, the DIFER machine comprises an outer system and an inner system. The outer system comprises at least one or more impact units, an upper and/or lower, each comprising an impact ram. The inner system comprises at least one or more static press units, each comprising a press ram and a punch, and a central unit, preferably comprising a vibrator unit, and a tool unit. The tool unit comprises a moulding die mounted in a moulding die table or carrier movable and attached to the central unit, an upper punch removably attached to the upper press unit and a lower punch removably attached to the lower press unit or the stationary anvil. The central system comprises a movable moulding die carrier, which holds a moulding die. The said moulding die carrier has at least two or more function stations. A processing and a service station. At the processing station, the moulding die is positioned concentrically with the upper and lower punches.

It is a characteristic feature of the machine according to this first embodiment that the upper impact ram(s) are caused to perform at least one or more than a single stroke with such a velocity against the press ram(s), which is pressed against the punch(es) with a continuous static pressure, where said upper systems accelerate downwards with a velocity v₁ and the lower systems with a velocity v₂, said movable members having such masses and said velocities being so high that the impulses of the downwards movable masses and of the upwards movable masses will be essentially equal, i.e. such that the following condition applies:
m₁v₁=m₂v₂
where m₁ is the total mass of the masses moving downwards, and m₂ is the total mass of the masses moving upwards at the impact; that the kinetic energies of the movable masses, i.e.

$${E}_{1} = \frac{{m}_{1} {v}_{1}^{2}}{2} , and$$

$${E}_{2} = \frac{{m}_{2} {v}_{2}^{2}}{2} ,$$

respectively, are essentially transferred to the working material in the mould cavity and are so great that the working material is plasticised and flows out to fill all parts of the mould cavity, when the punches are maximally brought together, for the formation of said body with desired shape, and that the die is essentially stationary during said stroke.

Additionally, the mass m of the striking unit is preferably essentially larger than the mass of the material. By that, the need of a high impact velocity of the striking unit can be somewhat reduced.

The striking unit must emit enough kinetic energy to form a body when shocking the material inserted in the compression mould. With a higher velocity of the stroke, more particle vibrations, increased friction between particles, increased local heat, and increased inter-particular melting of the material will be achieved. The bigger the stroke area is, the more particle vibrations are achieved. There is a limit where more energy will be delivered to the tool than to the material. Therefore, there is also an optimum for the height of the material.

What has been described above about the energy transformation and wave generation also refer to a solid body. By a solid body is here meant a body where the target density for specific applications has been achieved.

According to a second, conceivable embodiment, the lower impact unit of the said outer system and the lower press unit of the said inner system comprise a counter-action device in the form of an anvil assembly under the central unit. Said anvil assembly including an stationary anvil unit and a lower punch. The said anvil assembly counteracts the pressure and shock energy which is delivered by the upper static press unit and upper impact unit. The upper static ram and the upper impact ram move downwards during the impact step, to meet the counter-action device as an anvil assembly. According to a second embodiment, with a stationary anvil under the central unit, the anvil assembly is suspended via shock absorbers.

According to a third, conceivable embodiment, vibration of the inner system in combination with or without static pressure on the working material from the inner system, the working material in form of powder is vibrated to increase the pre-compacted material density. By the use of vibration the particles in the pre-compacting mould will move closer together, forcing out air or gas from between the particles and they will orient themselves so as to more easily be compacted. Thereby, already before the pre-compaction starts, a higher density is achieved. The pre-compaction will therefore not start from a loosely packed powder, but from a more densely packed powder. Therefore, reduced pre-compaction pressure may be required. Should the vibration continue during the pre-compaction step, a higher density will be achieved using the same pre-compaction pressure. The higher density achieved during pre-compaction will facilitate the compression step. The invention also concerns a function comprising the steps of inserting the solid material in a mould, possibly pre-compacting the material at least once with a pre-compacting means.

According to a fourth, conceivable embodiment the machine includes an energy retention step which aims at keeping the delivered energy inside the solid body produced. It is physically a compaction with at least the same pressure as the pre-compaction of the powder. The result is an increase of the density of the produced body by about 1-2%. It is performed by for instance letting the inner system stay in place on the solid body after the impact and press with at least the same pressure as at pre-compaction, or release after the impact step. The idea is that more transformations of the powder will take place in the produced body.

The first and the second embodiment can independently be combined with the third and the fourth.

This and other objectives can be achieved therein that the central unit comprises one or more carriers, which contain and carry one or a plurality of identically equal or different, tool units, each one of which comprises a moulding die having a mould cavity for the working material.

It is also possible to first compress a material in a first mould by at least one stroke. Thereafter the material may be moved to another, larger mould and further material be inserted in the mould, which material is thereafter compressed on top of or on the sides of the first compressed material, by at least one stroke. Many different combinations are possible.

The pre-compacting mould may be the same as the compression mould, which means that the material does not have to be moved between the pre-compacting and compression. It is also possible to use different moulds and move the material from the pre-compacting mould to the compression mould. This could only be done if a body is formed of the particulate material in the pre-compacting step.

Said carriers including at least one carrier which is stationary during the impact step and which contains at least one such tool unit; that motion devices are provided for indexing the carrier(s) in a horizontal plane for positioning the tool units in different function stations. That said function stations comprise a processing station, in which the moulding die is coaxial with the upper punch and lower punch, which is a step for filling a cavity in the moulding die with working material, which shall be formed to said body with desired shape, a step for ejection of the formed body out from the moulding die, a step for pre-compacting and vibrating the working material to a pre-compacted material body, a step for compression the pre-compacted material body with a continous pressure from the inner system in combination with a kinetic energy shock generated by the movable masses of the outer system ram(s), which comprise at least one or more single shock, essentially transferred to the working material in the mould cavity and are so large that the working material is plasticised and flows out to fill all parts of the mould cavity when the punches are maximally brought together, to form said body with desired shape. The counter-action device under the carrier provided in the processing station, could either be a lower press unit and a lower shock unit or the said stationary anvil.

Among further aspects of the invention, it may be mentioned that the invention aims at achieving also one or more of the following advantages:
to essentially isolate the carrier of the central unit, which is stationary during the impact step, from impact forces at the impact step and from shock waves from the impact, wherein the carrier may be designed to be light and need not require any great mechanical strength,
to use a light carrier in the central unit, and to eliminate heavy foundations, which according to prior art have had the purpose of absorbing shock waves. This is obtained by counteracting shock waves, which in turn is possible due to that both the inner and outer systems can be counter-acting and synchronised, giving both systems a force vector balance,
to increase the mobility of the DFIER machine due to the absence of any heavy foundation, as a result of the counteracting press and shock configuration.
to provide that the compression energy of rams can be used essentially for effective work in connection with working with a material instead of being lost in tools and auxilliary equipment, such as in the carrier of the central unit, in the stand and the foundation, which in turn can create improved possibilities to work and/or to form materials which previously has not been possible to a desired degree,
to make it possible to compact powders or other workable materials, such as metal powders, ceramic powders or composite powders consisting mainly of metal, ceramic and/or polymeric powders, to a higher and more even density than what has been possible by means of prior art because of losses of energy in tools and auxiliary equipment and better control of the shock energy due to more exact knowledge of the working material position relative the impact rams than has been experienced with prior art,
to enable an easy and quick adjustment of the distance of the impact unit(s), respectively, above and below the central unit, respectively, to make it possible to design the impact unit(s), such that shock waves are superimposed,
to make it possible to manufacture compacted bodies in the machine with desired shape from metal, ceramic or polymer powders, essentially without communicating pores and with such a great strength that they can be pushed out from their mould cavity without being damaged and be moved to a furnace in order, in a subsequent treatment, to be heated to sintering temperature preferably lower than that needed using conventional powder forming techniques, wherein the powder grains, which were softened and changed as to their shape in the machine, will be welded together (sinter, coalesce) for the achievement of a very dense body with high strength,
to make it possible to manufacture compacted bodies in the machine with desired shape from material powder or a solid body where the working material is equidistant from the impact ram(s) of the outer system. It results in that the material is less prone to get gradients, cracking and microfractures,
to enable an even higher density with less shock energy delivered to the working material, by means of shaking (vibrating) the working material inside the mould prior to and during pre-compaction which may be performed by vibrating the whole inner system,
to enable higher density of the working material with less delivered energy by means of pre-heating and/or heating the working material in the moulding die and by electrical discharge,
to prevent formed material bodies from cracking or getting micro-fractures by keeping the static pressure of the internal system intact until the shock wave has faded out in a retention step. It both prevents the material from cracking as well as a higher density of the formed body is achieved,
to enable to change the weight of both the impact rams of the outer system, by having a modular weight insertion system. This gives the opportunity to modulate the speed and mass of the system, as it gives different results for different materials, and
to enable longer tool life and reduced tool investments due to the reduced required shock energy.

The features which may be modified within the definition of the functionality of the invention are for instance:
1) the direction of striking, may be in one, two or more directions,
2) the vibration, may be during the pre-compaction step and/or the compression step and/or the energy retention stage,
3) the number of pre-compactions,
4) interval between pre-compaction stokes,
5) temperature during pre-compaction
6) pre-compaction pressure
7) the same parameters may be modified for the compression step,
8) impact stroke pressure and energy, may be the same or be different for different impacts,
9) retention in one or more steps may be used or not,
10) atmospheric pressure in the mould, may be decreased or not,
11) use of other gases than air, for instance inert gas or a reactive gas,
12) the temperature of the mould and material, may be increased and in some instances decreased or may be ambient temperature,
13) the material to be formed may be particulate, such as powder, pellets or grains, or solid,
14) electrical current may be used or not,
15) the vibration may be modified as to amplitude, frequency or direction, may be vertical and/or horisontal,
16) the pre-compaction mould and compression mould may be the same or different,
17) the number of steps may be modified, some steps may be repeated several times after repeating an earlier step, more material may be filled in the mould after pre-compaction or compression and thereafter pre-compaction and/or compression may be repeated,
18) the relation between the mass of the impact ram or rams, the mass of the punch or punches and the mass of the material to be formed may be modified,
19) energy retention may be used or not.
20) laser could be used during the filling step to heat the powder and make it more prone to transformation.

Further characteristic features and aspects of the invention will be apparent from the appending patent claims, the detailed description of the invention, and from what is disclosed in the above mentioned Swedish patent applications, which have been included in the present application by reference.

### BRIEF DESCRIPTION OF DRAWINGS

In the following detailed description of the invention, two preferred embodiments will be described with reference to the accompanying drawings, in which

FIG. 1 is a cross-section view of an impact machine in its initial position according to said first embodiment, a processing station facing the viewer.

FIG. 2 is a lay-out of an impact machine according to a second embodiment in two different perspective views, which impact machine comprises an upper ram above said central unit and a counter impact member in the form of a movable anvil under the central unit;

FIG. 3 shows the same impact machine with the lower punch in start position and the moulding die filled with uncompressed powder.

FIG. 4 shows the same impact machine with the inner impact system statically compressing the powder with the upper and lower punch.

FIG. 5 shows the same impact machine with the inner impact system statically compressing, while the outer impact system impacts the pre-compressed powder to a compacted material body.

FIG. 6 shows the same impact machine extruding the material body;

FIG. 7 shows the same impact machine with the impact rams in the outer impact system returned to their initial positions after the impact.

FIG. 8 shows the same impact machine after the material body is removed from the moulding die.

FIG. 9 is a perspective view of an impact machine divided into defined horizontal cross-sections;

FIG. 10 is a view along the line A-A, a horizontal cross-sectional view through the upper part of the outer impact system;

FIG. 11 is a view along the line B-B, a horizontal cross-sectional view through the upper part of the inner impact system;

FIG. 12 is a view along the line C-C, a central vertical cross-sectional view;

FIG. 13 is a view along the line D-D, a horizontal cross-section view through the central part of the inner impact system;

FIG. 14 is a view along the line E-E, a horizontal cross-section view through the lower part of the inner impact system;

FIG. 15 shows the same impact machine in a vertical cross-sectional F-F, with the housing climate process control system.

FIG. 16 is a three dimensional view of the inner impact system, with supporting parts, moulding die table sliding bar and low and upper static press tables.

FIG. 17 is a three dimensional view of the upper inner impact system, with the mouldarised tool system.

FIG. 18 is a cross-section view of the inner impact system in its initial position with coolant fluids inlet and outlet of the tool;

FIG. 19 is a cross-section view of the inner impact system, and the moulding die filled with uncompressed powder;

FIG. 20 is a cross-section view of the inner impact system statically compressing the powder with the upper and lower punch;

FIG. 21 is a cross-section view of the inner impact system statically compressing the powder with the upper and lower punch, while the outer system impacts the pre-compacted powder to a material body;

FIG. 22 is a cross-section view of the inner impact system extruding the material body;

FIG. 23 is a cross-section view of the inner impact system white the material body released from the moulding die.

### DETAILED DESCRIPTION OF THE INVENTION

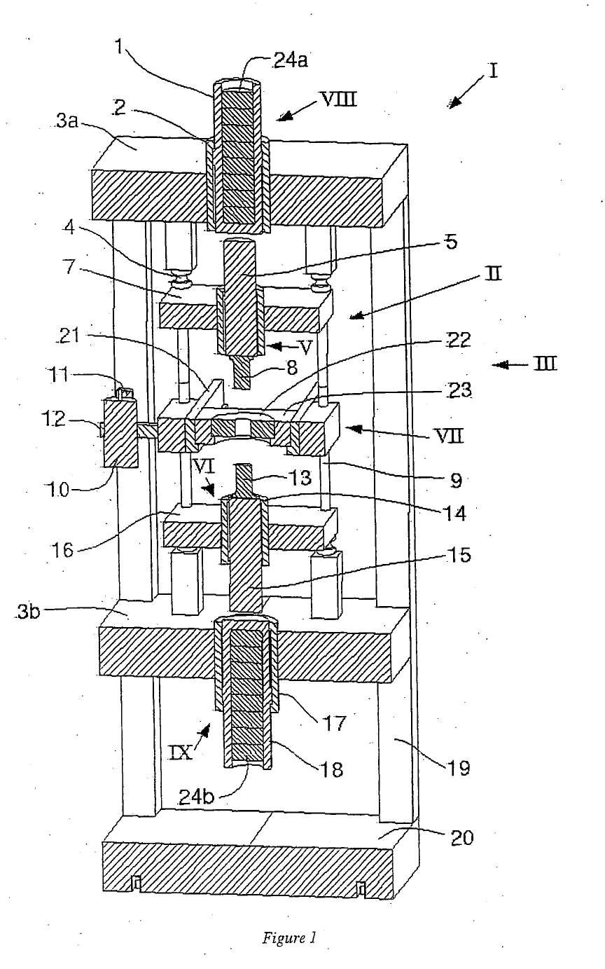

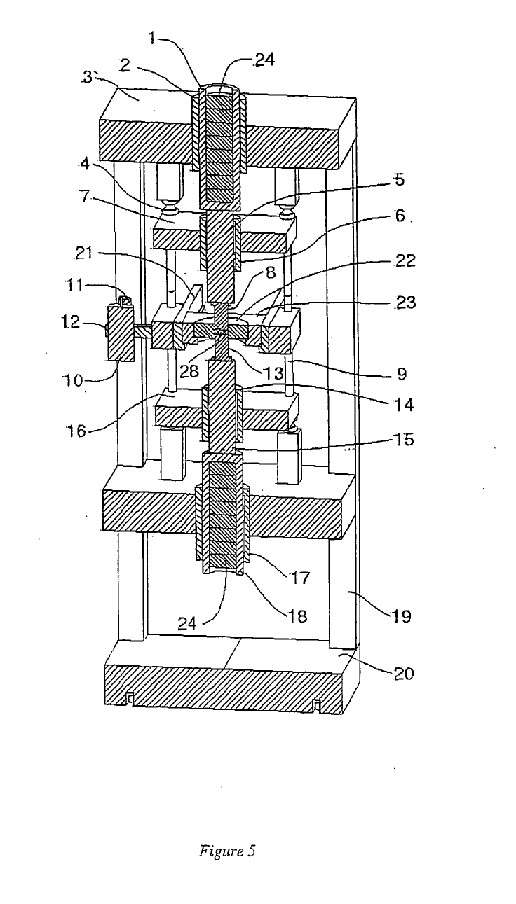

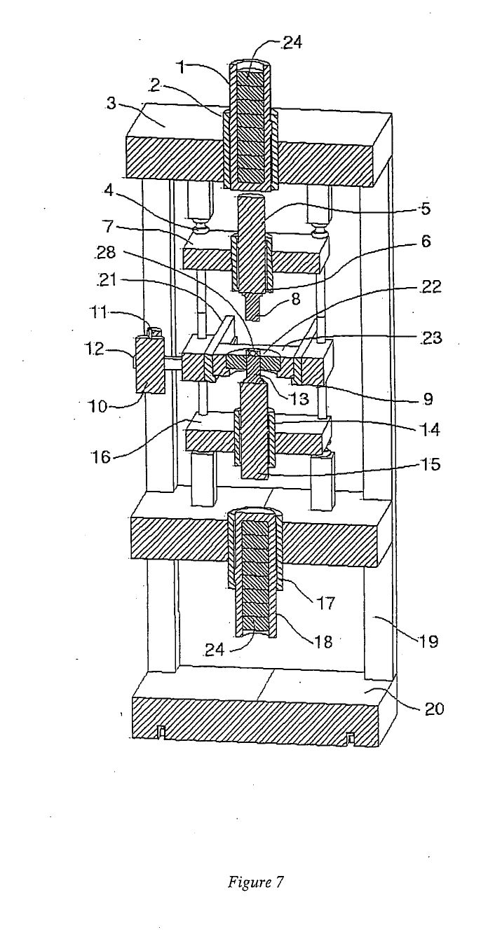

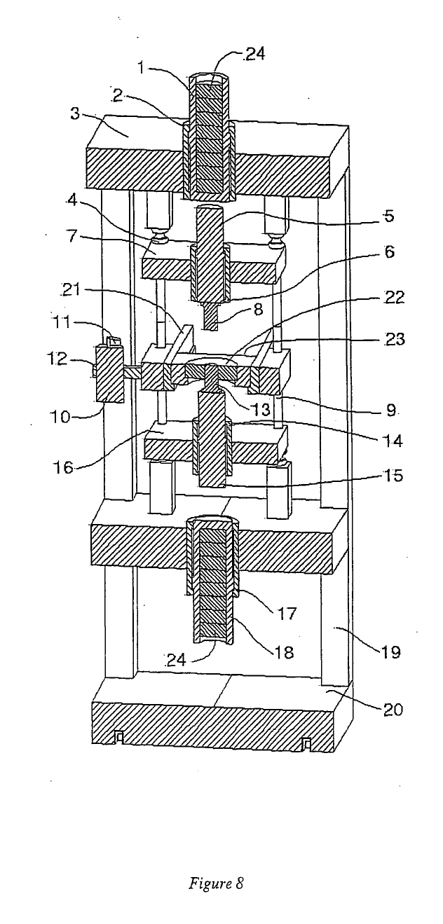

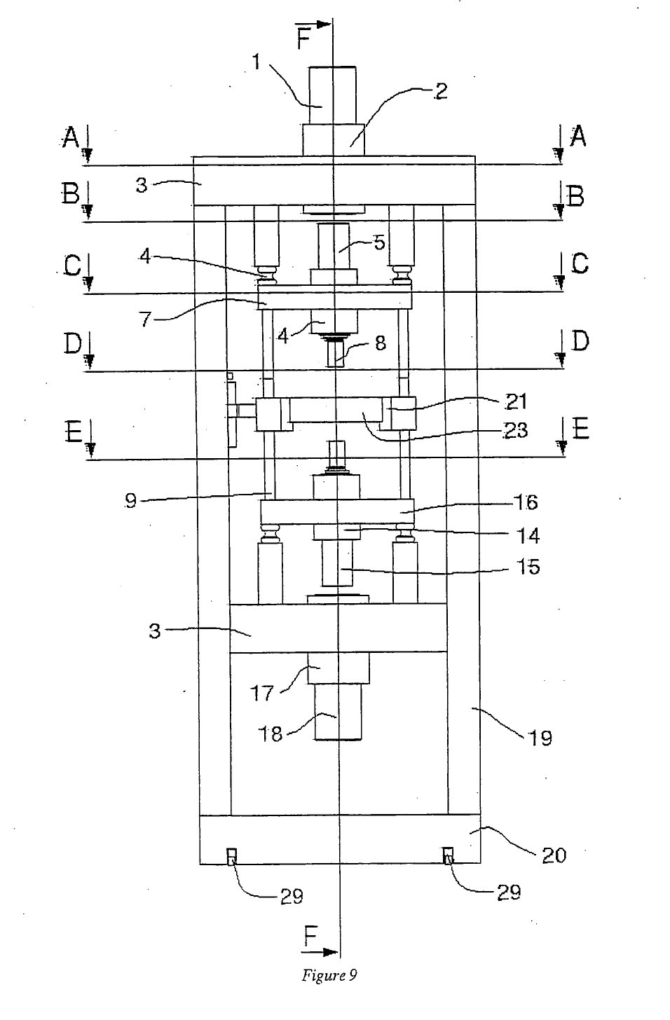

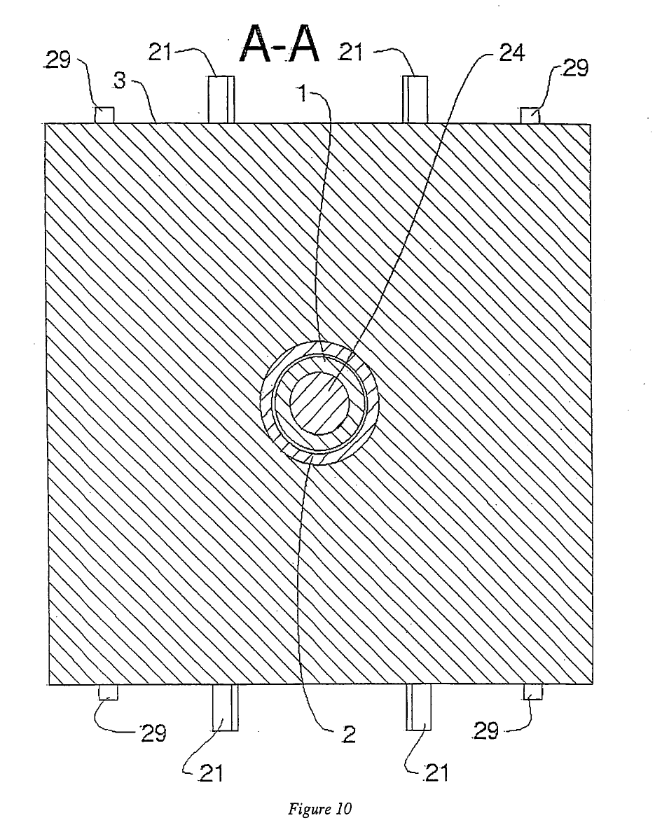

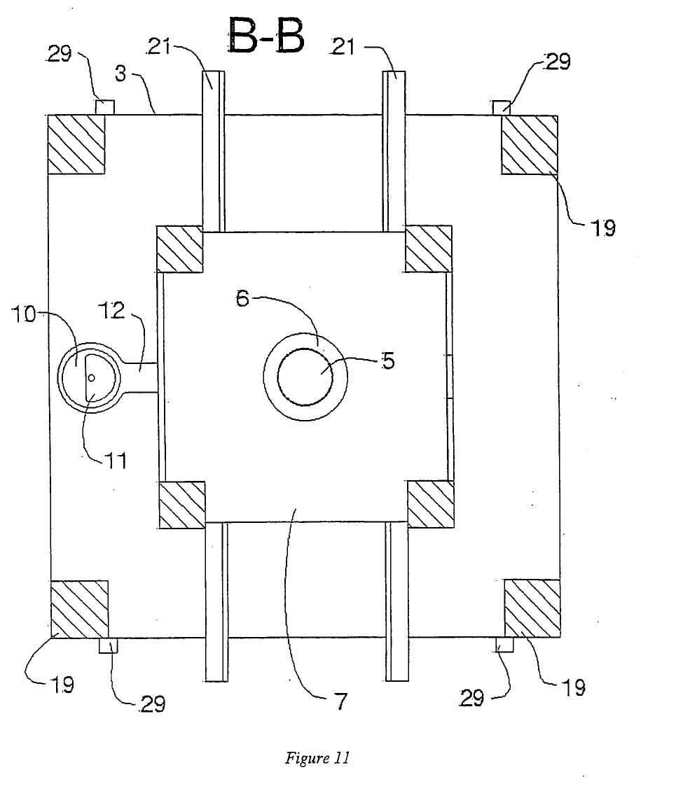

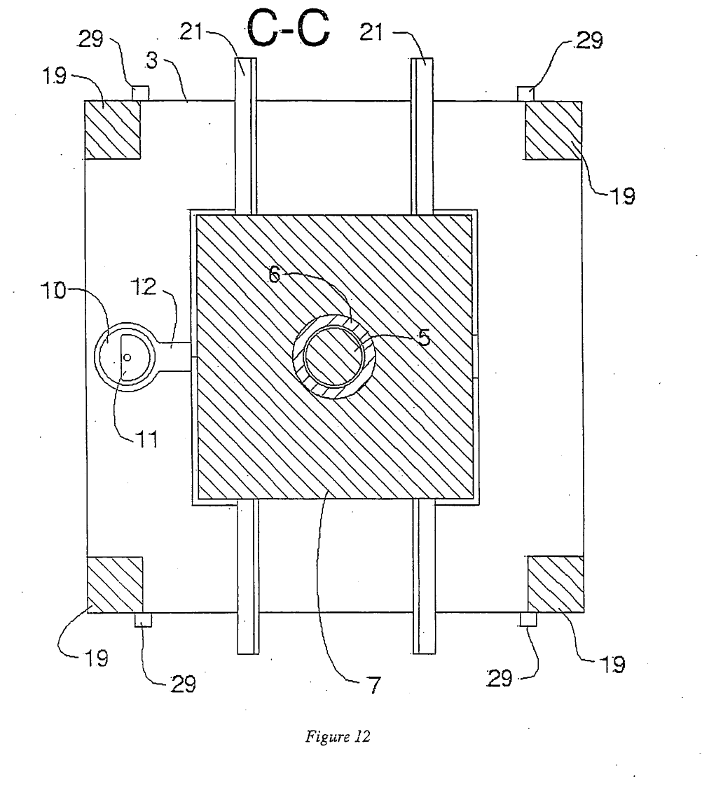

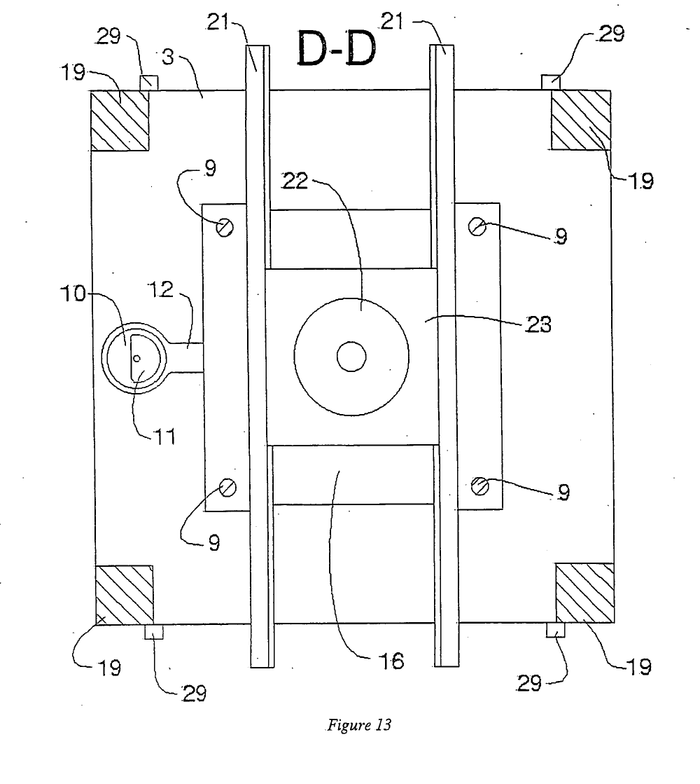

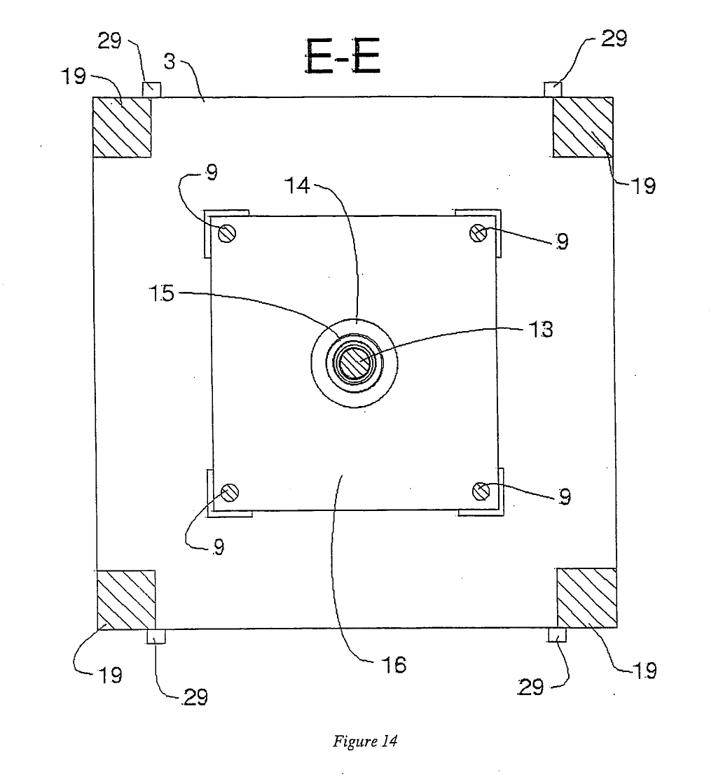

### Embodiment According to FIG. 1-FIG. 15

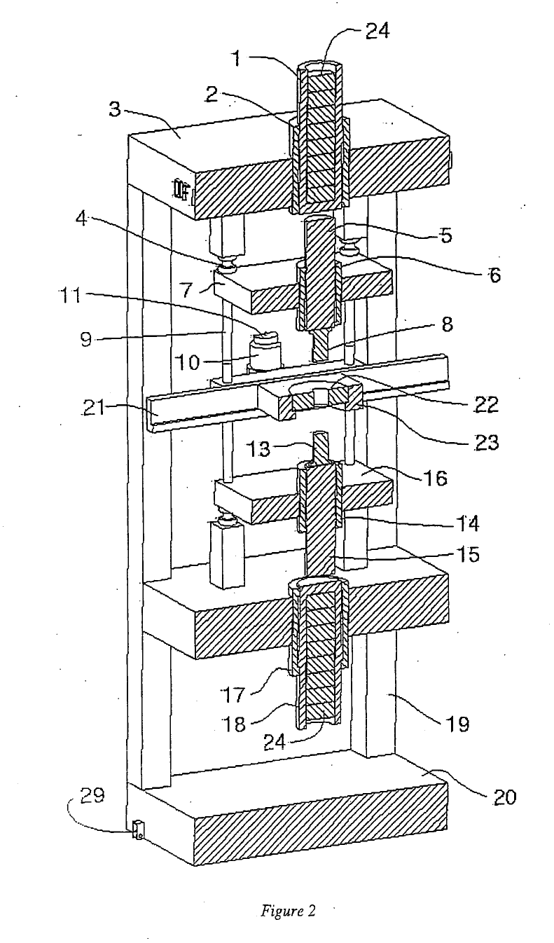

With reference first to FIG. 1, a DFIER machine I is generally designated I. Its main parts, FIGS. 1 and 2 consist of an inner system II and an outer system III, and a stand. The inner system II consist of an upper press unit V, a counter-acting lower press unit VI and a central unit VII, comprising a slidable moulding die table 23. The outer system III consist of two counter-acting impact units with modular weight systems 24, an upper impact unit VIII, and a lower impact unit IX. The lower units of the inner and outer system can be replaced with one common stationary anvil, not shown here.

The stand consists of two horizontally positioned strong steel plates 3a and 3b which are anchored to four columns 19, which extend upwards from the foundation 20. The inner system II is connected to the outer system III by a system 4 allowing for horizontal motion of the inner system relative to the outer fixed system. The DFIER machine I may also be equipped with a rolling device 29 for machine movement.

The upper impact ram system VIII comprises an upper impact ram 1, a upper impact ram housing 2 connected to the upper horizontally positioned steel plate 3b and modular weight systems 24a. The lower impact unit IX comprises a lower impact ram 18, a lower impact ram housing 17 fixed in the lower horizontally positioned steel plate 3b and modular weight systems 24b. The impact ram housings 2 and 17 are open at both ends to provide for access to the ram and the adjustable ram weight system 24a and 24b. The impact ram housings 2 and 17 accelerates the impact rams 1 and 18 by hydraulic pressure. The weights are locked in position in the impact rams 1 and 18 by a locking device not shown in the drawings. The weights 24 could be either automatically positioned by means of a robot arm or manually retrieved from or installed into the rams 1 and 18. The inner system's II upper and lower press units V and VI are connected to an upper static press table 7 and a lower static press table 16. The upper static press table 7 and the lower static press table 16 are connected by four vertical rods 9. The said upper static press table carries the upper press ram housing 6 including a press ram 5. An upper punch 8 is replaceable united with the upper static press ram 5. The lower static press table 16 supports the lower static press system VII, comprising a lower static ram housing 14 including a lower press ram 15. A lower punch 13 is replaceable united with the lower press ram 15. The press ram housings 6 and 17 are open at both ends to provide for access for the impact rams 2 and 18 to impact on the outer ends of the press rams 5 and 15.

The inner system II and outer system III can preferably be a hydraulic, pneumatic, spring-actuated or electrical device. The inner press systems V and VI and outer shock systems VIII and IX are individually controlled and independently actuated of each other by independent actuation means. However, the inner press systems V and VI can not be spring-actuated. All theses said actuation devices are prior art and well known to a specialist in the field.

The central system VII is connected to the four vertical rods 9 and comprises the moulding die table 23 and the sliding bars 21. The said central system is movable vertically, sliding on the said vertical rods. The moulding die table 23 contains and carries one moulding die tool unit 22 at a time, which can be connected to a tool jukebox for automated tool changes. The moulding die tool units of the tool jukebox are changed with the moulding die tool unit 22 in the moulding die table 23 whenever a new component will be manufactured. A suitable material for the sliding table 23 is aluminium or any other light metal or light metal alloy, or any other light material, e.g. a polymer, or a composite material which makes the table of light construction.

The inner system II is connected to the outer system III by eight linking devices 4. The said linking devices that allows for 360° transversal to pressure axis motion of the inner system. Due to the force balanced system, the main purpose of the connectors is to allow for the transversal motion and align the inner system. The said linking devices provides for alignment of the inner system and specifically the static rams impact surfaces exactly parallel to the impact rams' impact surfaces. The said linking device can be a mechanical device comprised by low friction slip surfaces or by slewing brackets.

Connected with a vibrator connection arm 12, to the central system VII, is a vibrator rotor 10 including off axis rotor weight 11. By rotation around the said axis, the rotor weight by means of the vibrator rotor 10 will generate a dynamic oscillation of inner system II including the moulding die 23 and the powder material 26. The rotor could be electrically, hydraulic or pneumatic driven. Vibration of the powder 26 in the moulding die cavity 33 may also be performed by ultrasonic means.

The mass of the rotor weight 11 together with the acceleration will give the magnitude of the alternating force vector and the amplitude A of the vibration. The relation between the vibration mass and the inner system II mass is given by following equation:

$${m}_{rotor} = \frac{A}{r} {m}_{inner}$$

where r is the off center distance between the said rotor's weight center of gravity and the rotation axis of the vibrator rotor 10. The amplitude is changed by changing the mass of the asymmetric weight for a given frequency and the off axis distance r.mᵢₙₙₑᵣ refers to the mass of the inner system II.

The moulding die table 23 is movable in a horizontal plane. The moulding die table 23 is connected to and slides on two sliding bars 21 and can be fixed in different function stations. The moulding die 22 adopt desired, indexed positions in two function stations, which according to a preferred embodiment consist of the following stations:
i a processing station
ii a tool service station

A second or a multiple of moulding die tables can be added parallel to the first moulding die table 23, carrying a second or a multiple of moulding, dies 22.

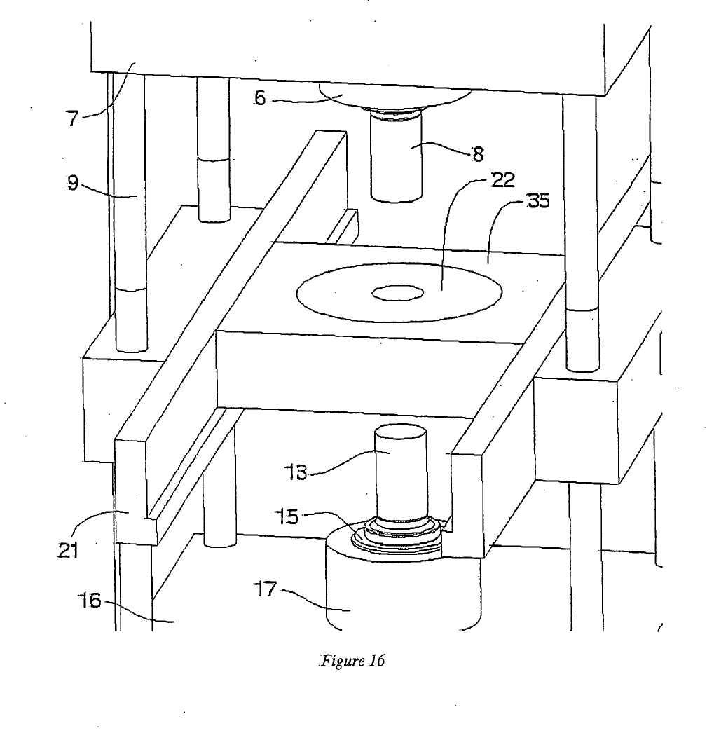

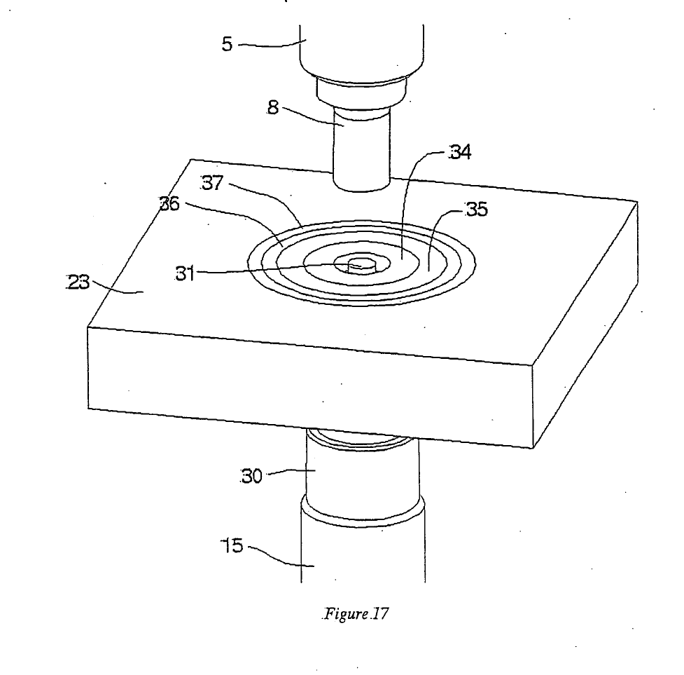

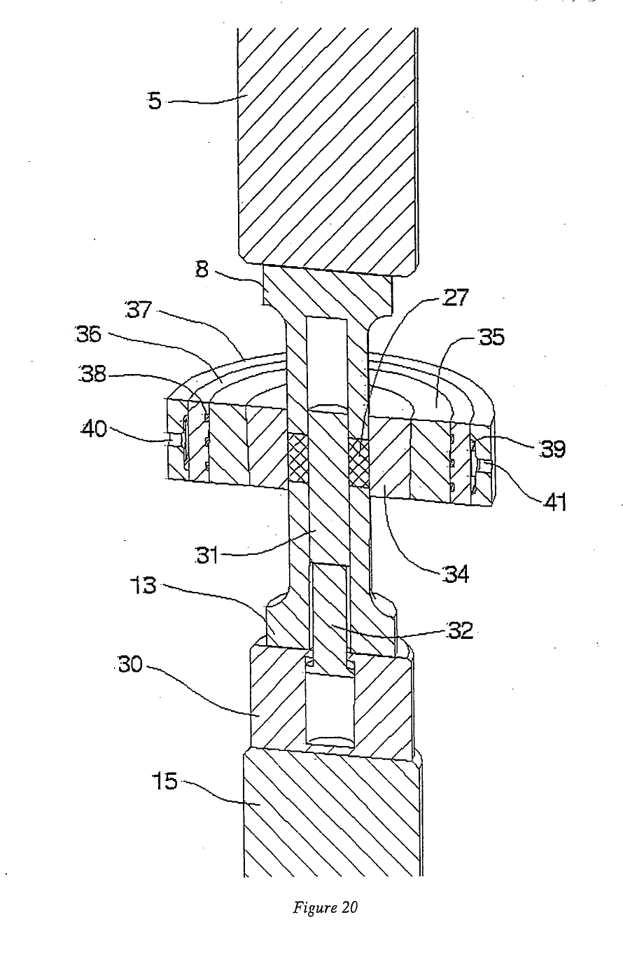

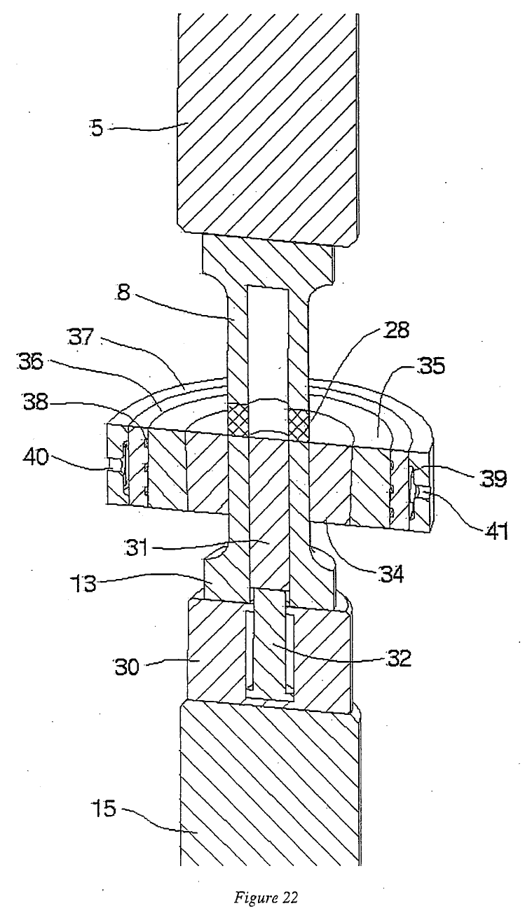

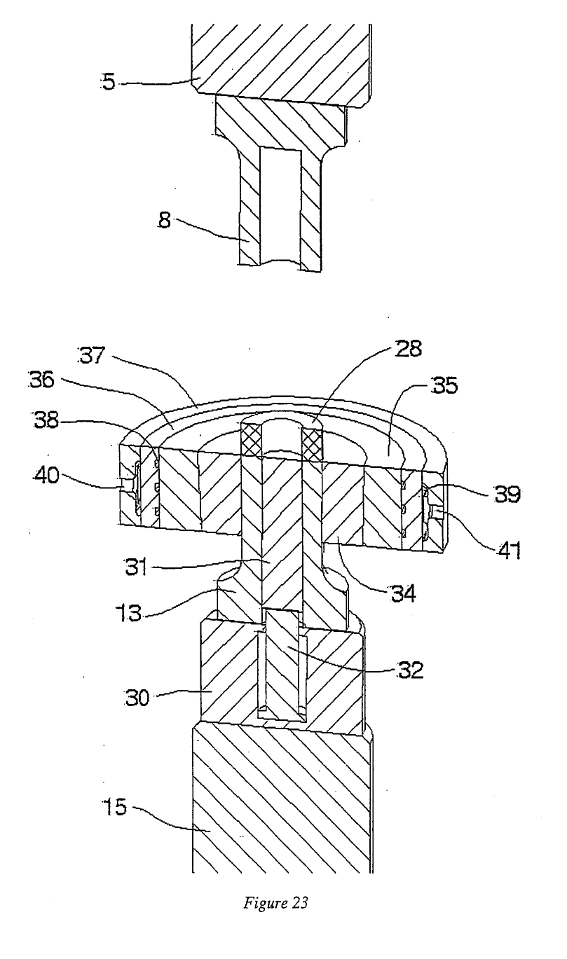

### Embodiment According to FIG. 16-FIG. 23

The main parts of the tool unit comprises a lower punch 13, an upper punch 8, a moulding die 22 and a core rod 31. Due to the fact that the tool unit comprises one or more core rods it is possible to manufacture components including through holes and cavities. The lower punch is replaceably united with a punch base cylinder 30. The said punch base cylinder includes as punch base ram 32 on which the said core rod is removably fixated. The said punch base ram is hydraulic driven for vertical motion. The said punch bases cylinder is replaceably united with the lower static press ram 15. The said punch bases cylinder is optional and not needed for manufacturing of components not including through holes. In this option the lower punch is directly united with the lower press ram 15. The upper punch is directly replaceably united with the upper press ram 5. The moulding die 22, the core rod 31 and the lower punch 13 and the upper punch 8 together forms the moulding die cavity 33. The walls of the moulding die 22 shape corresponds to the shape of the components outer shape and the said core rod geometry gives the hole shape of the component.

The moulding die 22 comprises multiple rings including an inner moulding die matrix 42, a die load ring 35, a die heating ring 36 and a die cooling ring 37. The said die heating ring is provided with one or more heat cavities 38 round the said die heating ring inner diameter. The said heat cavities give room for heating wires or any other heating means, e.g hot fluid. The said die cooling ring is provided with one or more cooling channels 39 round said die cooling ring inner diameter. The coolant inlet 40 and outlet 41 provides for coolant fluid to flow through the said coolant channels. Likewise the coolant channels can also be used to heat the tool using a hot fluid for example oil. The die matrix's 34 outer wall is tapered so that it only the said die matrix is changed and the said die loading ring, die heating ring and die cooling rings can be used for manufacturing of different component geometries.

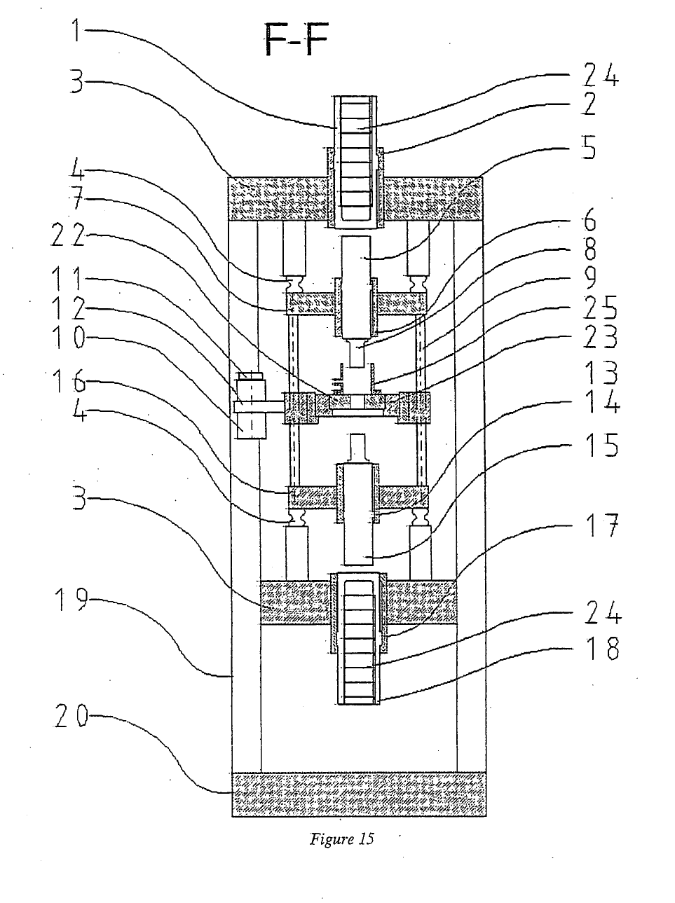

The tool can be equipped with a controlled processing atmosphere chamber 25 shown in FIG. 15. The chamber is positioned on top of the moulding die 22. The inner diameter is equal to the upper press ram 5. The said atmosphere chamber 25 is equipped with a sealant ring, not shown in the figures, at the top of the inner side of the said atmosphere chamber. When the upper press ram is lowered into the said atmosphere chamber, the sealant ring provided for a sealed connection between the said upper press ram and the said atmosphere chamber. The said atmosphere chamber is high enough so that the position of the lower edge of the upper punch 8 is not entering the moulding die cavity 33 as the upper press ram barely is inserted into the said atmosphere chamber. When the lower punch 13 is inserted into the moulding die 22 a air tight chamber is formed. Air is evacuated through a nozzle the in the atmosphere chamber 25. A protective gas atmosphere could be obtained using two or more nozzles in the said atmosphere chamber. An alternative atmosphere chamber can be obtained by connecting the climate cylinder directly on the punches 8 and 13.

The tool can be equipped with an electrical discharge component capable of providing a alternating and direct current to the punches 8 and 13. In this option the wall of the moulding die matrix 34 is equipped with an electrically non-conductive layer. The connections between the upper punch 5 upper press ram and lower punch 13 and lower punch, are sealed with electrically non-conductive layers.

### i-The Processing Station

In the processing station the moulding die table 23 is positioned so that the moulding die 22 centre axis coincides with the axis of the upper and lower press units V and VI and the punches 8 and 13. The processing station i consist of the following station steps:
a tool lubrication step
b filling step
c pre-compaction step
d compression step
e retention step
f ejection step
g tool cleansing step

In the tool lubrication step the tool surfaces may be coated by any lubrication medium with the aim to reduce the friction between the wall of the moulding die 22 and the working material increasing the density of the pre-processed material body 27 and the compacted material body 28. The lubrication will prevent working material to, be in direct contact with the die walls of the said moulding die. This will reduce or eliminate working material to stick to the walls of the said moulding die and also reduce the friction force forcing the ejection step. The compression may be performed in a lubricated moulding die 22. Connected to the DFIER machine I, an automated device coats the walls of the moulding die 22, the core rod 31 and the surfaces of the punches 8 and 13 with a predetermined lubricant and film thickness. The lubricant may be added to the tool surfaces by means of e.g. spraying, smearing, rolling or polishing. Alternatively the tool lubrication can be performed with internal lubrication either premixed with the working powder material or as colloid on the powder particles of the working powder material.

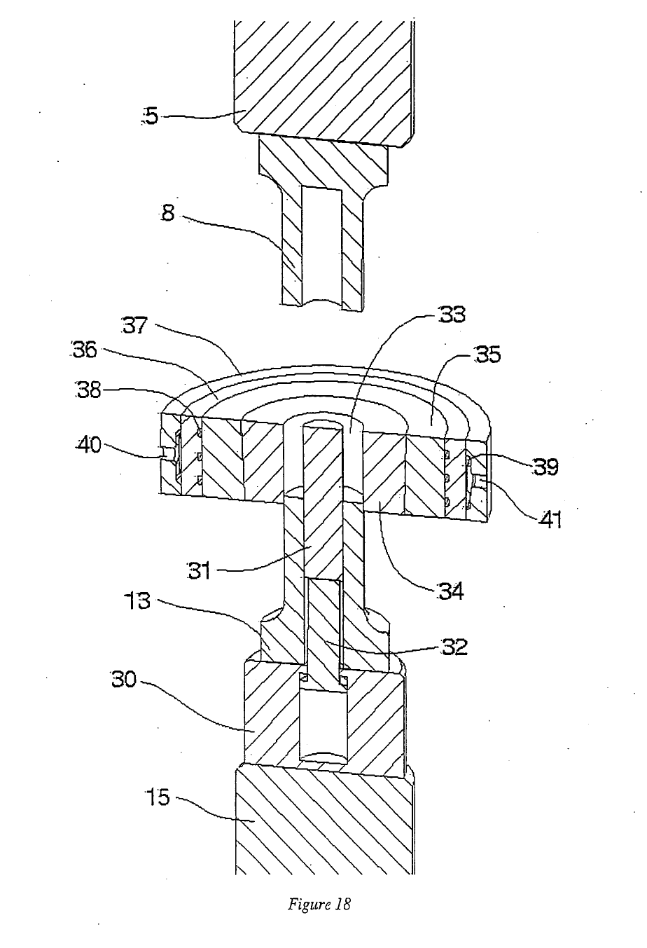

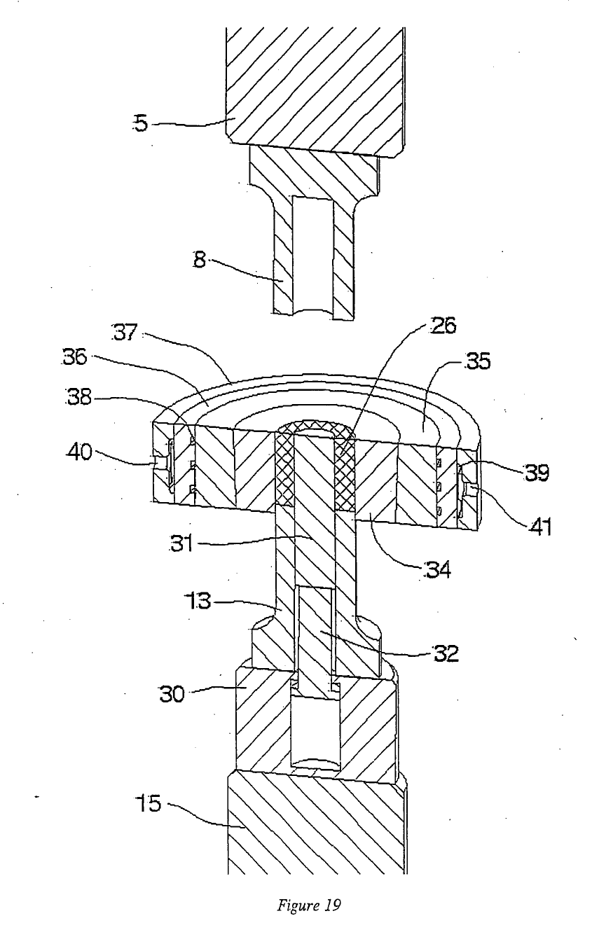

In the filling step processing material is fed into the tool cavity 33. The processing material could be in any form of powder of solid material. In the illustrated example it is supposed that the working material consists of material powder; see the preamble of the description. In its simplest embodiment, the filling device can consist of a container cavity. The lower edge of the filling container rests against the moulding die table 23 and the moulding die 22 sliding against the upper surface of the said moulding die during a directed movement. The filling container is mounted on an arm and has an opening in the container resting on the moulding die 22 top surface. The filling container can be refilled or have an automatic filling system by means of not shown re-filling members. The lower press ram 15 of the inner system II is positioned so that the upper surface of the lower punch 13 is inserted in the moulding die 22, FIG. 18. The moulding die cavity 33 is filled with a pre-determined amount powder material 26, FIG. 19.

If the component includes a through hole as illustrated in the example the upper edge of the core rod 31 is aligned with the upper surface of the moulding die 22. The said core rod is positioned by the hydraulic driven punch base ram 32. The moulding die cavity volume is adjusted by axial movement of the lower punch 13 relative the moulding die. The relative axial displacement can be performed by ether vertical movement of the lower press ram 15 or/and the central unit VII. After filling, the filling container is turned away by means of said motion devices. Filling the powder scan alternatively be performed in discrete weighted batches. At one station the cup with the powder is weighted. A robot or extender arm collects the filling container with the right amount of powder and feeds it into position over the moulding die 22. When the filling container is positioned above the moulding die cavity 33 the extender arm feeds the said moulding die cavity with the pre-weighted powder, either by a opening in the container cavity or by a rotational pouring motion. The powder can be filled into the moulding die cavity by other means other than described above, e.g. through a direct piping. If the working material is not of powder, but of solid material, a robot or an automated extender arm can feed the moulding die cavity 33 with the material.

The working material can be heated prior to filling in the moulding die cavity 33. Pre-heating 30 may be performed by any means of heating device, e.g. conductive heating integrated in the filling container cavity, induction heating for suitable material types or by laser heating, preferably for working material inform of uncompressed powder which can be heated by at least one laser beam as the powder material is poured into the moulding die cavity 33.

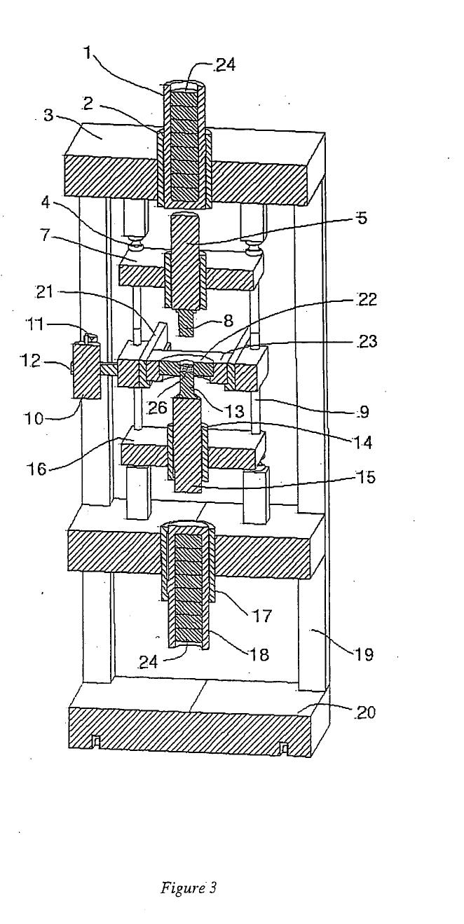

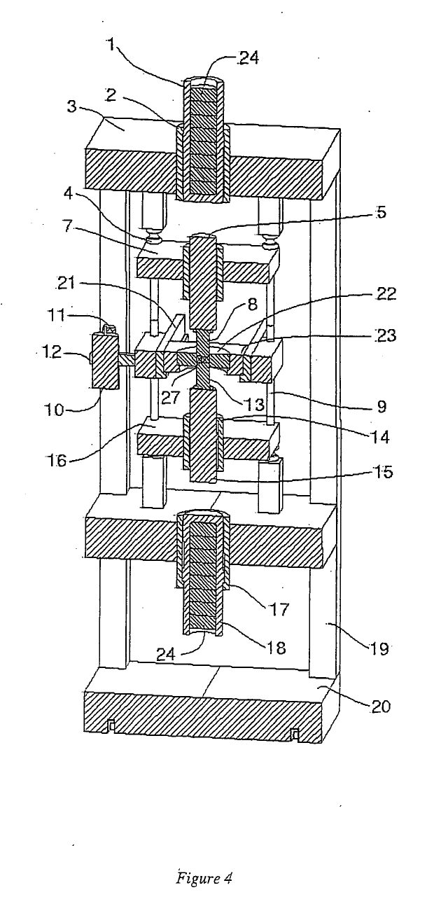

In the pre-compaction step the powder is compressed by a simultaneous static pressure, vibration, air evacuation and alternating electrical current or by a combination of either of all, or a combination of the said functions. FIGS. 3, 4, 19 and 20 shows the pre-compaction step. The upper impact ram 1 and the lower impact ram 18 are positioned at the their end potions as seen in FIG. 3. The lower press ram 15 is positioned so that the upper edge of the lower punch 13 is inserted into the lower part of the moulding die 22, FIGS. 4 and 19. The upper press ram 5 is lowered until said upper press rams lower edge is inserted into the atmosphere chamber 25. The evacuation of the contained is evacuated through a evacuation nozzle on the said atmospheric chamber, or the contained air is replaced by an alternative gas. The upper press ram 5 continues the vertical movement until the maximum static pressure is obtained. Simultaneously the lower press ram 15 is vertically in opposite direction to the said upper press ram. The final position of the rams is positioned so that the pre-compacted material body 27 is positioned approximately equidistant from either of the upper and lower surfaces of the moulding die 22.

During the described pre-compaction the vibrator rotor 10 may oscillate the inner system and the uncompressed powder material 26. The heating wires positioned in the die heating ring 36 may heat the tool to a pre-determined temperature. The pre-compaction pressure in the press rams 5 and 15 is controlled individually, by controlling the hydraulic pressure driving the said press rams.

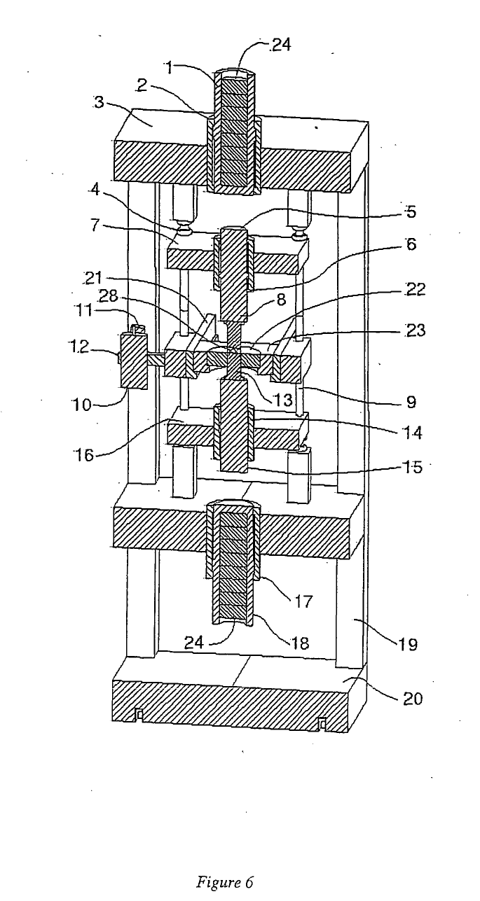

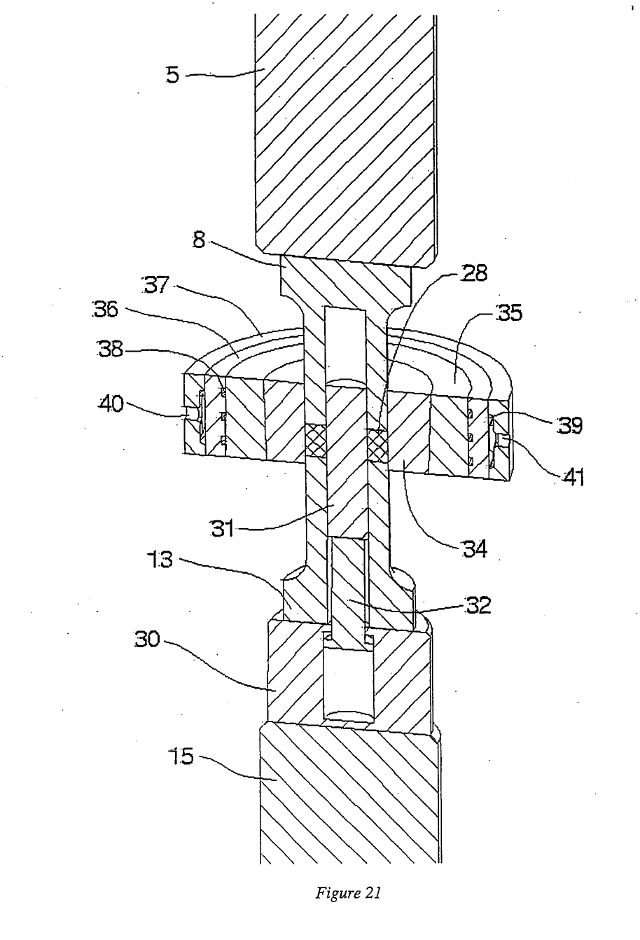

In the compression step the pre-compacted material body 27 is compacted by a simultaneous dynamic shock, static compression pressure, direct discharge current, reduced atmospheric pressure and tempered moulding die 22. FIGS. 6 and 21 shows the sequence of the compression step. The moulding die cavity 33 contains the pre-compacted material body 27. The static pressure is obtained by the counter-acting pressure form the upper and lower press rams 5 and 15. The shock is generated by simultaneous acceleration of the upper impact ram 1 and the lower impact ram 18 to impact on the outer ends of the corresponding upper press ram 5 and lower press ram 15. The shock wave is transmitted through the upper and lower press rams 5 and 15 and through the upper and lower punches 8 and 13. The acceleration distance between the two impact rams 2 and 18 and the two press rams 5 and 15, is adjusted so that the said impact rams are synchronised impacting with the same velocity and timing on the corresponding said press rams. The shocking sequence may be repeated in any number of cycles and variation of kinetic energy. The impact rams and 18 is retracted to their outer position after completed single or multiple shock sequence. The timing of shock impacts of the upper and lower impacts rams 1 and 18 may also be performed unsynchronised, in order to controll the location where the shock waves from the upper impact ram 1 and the lower impact ram 18 are met.

The required shock energy is controlled by the acceleration distance until the impact rams 1 and 18 impacts on the corresponding press rams 5 and 15, under a constant actuation pressure on the said impact rams. The acceleration of the impact rams can also be controlled by varying the actuation pressure.

By means of the modular weight systems 24a and 24b the impact velocity could be altered for a specific impact velocity. The weights 24 are stacked on top of each other and held in place by a locking lid locked securely by e.g. a bayonet joint. The relation between mass and impact velocity for a given shock energy is governed by the law of kinetic energy:

$${v}_{1} = \sqrt{\frac{{m}_{2}}{{m}_{1}}} {v}_{2}$$

where v₁ refers to the impact velocity for the given energy obtained with a mass of m₁ relative the impact velocity v₂ obtained with a ram mass m₂ for the same given shock energy.

In the retention step the pressure is retained in the compacted material body 28. This is performed by the counter-acting pressure from the upper press ram 5 and the lower press ram 15. The said compacted material body will be given time to relax. The moulding die may be cooled by a coolant fluid flushed through the coolant channels 39 in the die coolant ring 37 during this step. Cooling of the moulding die 22 can also be performed at any other occasion.

The ejection step includes ejection of the compacted material body 28 from the moulding die and may include cooling of the tool and returning to standard atmospheric pressure. The ejection of the compacted material body 28 from the moulding die 22 is performed by either vertically lowering or raising the central unit VII. The ejection may alternatively be performed by a vertical motion of the upper and lower press rams 5 and 15. The static pressure on the compacted material body may be obtained by the counter-acting pressure of the upper press ram 5 and the lower press ram 15 during the whole ejection cycle. When the compressed material body 28 is ejected outside the moulding die cavity 33 the static pressure is released by retraction of the upper press ram 5 to its upper end position. The core rod 31 is retracted to its lower end position by the punch base ram 32.

A retrieving arm collects the compacted material body 28. In the cleansing step the walls of the moulding die 22 and the walls of the core rod 31 may be cleansed.

The inner system II will be large enough providing room for axial motion of the static press rams 5 and 15. The static press rams 5 and 15 are designed with an axial displacement distance large enough to push the punch through the moulding die in order to extrude the material body out of the moulding die. Also, the upper punch 8 is moved away from the moulding die table 22 and the material body 28 enabling room for a retrieving and feeding mechanisms between the moulding die 22 and the punch.

### ii-The Service Station

In the service station the moulding die table is positioned at the outer end of the sliding bars 21. The moulding die 22 is in this position easily accessed for removal from the moulding die table 23 and a new moulding die could be positioned in the said moulding die table. The DFIER machine may be equipped with at least one additional moulding die table 23′. This will enable simultaneous shifting moulding dies 22′ simultaneously as the the the first moulding die table 23 with the first moulding die 22 is in position in the processing station.

The tool jukebox can carry multiple number of tool units where a tool unit comprises at least one or more upper punches, at least one or more lower punches, one moulding die, and an optional punch base. When a new product will be manufactured, different from the product produced with the present tool unit in the in process station, the moulding die 23 is positioned at the service station by a horizontal motion of the moulding die table 23 along the sliding bars 21. The moulding die 22 is lifted out of the moulding die table either manually or automatically using a robot. The said moulding die 22 is thereafter delivered into the tool jukebox. The upper, and lower punches 8 and 13 is manually or automatically collected from the corresponding upper and lower press rams 5 and 15 and delivered into the tool jukebox.

The tool jukebox can automatically deliver a stored and selected tool unit for easy access by either manually or automated robot collection. The collected moulding die 22′ is either manually or automatically inserted into the moulding die table 23. The new upper and lower punches 8′ and 13′ are also collected from the tool jukebox and positioned and fixed to the corresponding upper and lower said press rams. The moulding die table 23 carrying the new moulding die 22′ returns to the processing station by a horizontal motion of the said moulding die table along the sliding bars 21. The moulding die table 23 can be moved along the sliding bars 21 by any means of a controllable actuator, e.g. hydraulic, pneumatic cylinder or electrical driven actuator.

### EXAMPLE 1

This example illustrates the superiority of the DFIER machine comprising an inner static press system and an outer impact system of a single side acting ram configuration compared to a single outer impact system alone as described for the percussion machine in patent WO 97/00751, the so called first generation machines.

The DFIER machine configuration comprising an upper inner press system including a central unit, an upper outer impact system, and a stationary anvil. The central unit is a carrier for a moulding die with a through hole. The anvil positioned below the central unit provides as a support for the lower punch positioned on the anvil. The inner system comprises a press unit including a ram housing, a press ram and a upper punch as well as a vibration unit. The press ram housing is open in both ends so that the press ram is protruding from the ram housing at both the upper and lower end. The said press ram is acting vertically and positioned above the central unit. The upper punch is positioned on the lower side of the press ram. The press systems are actuated and controlled hydraulic with means for adjustable ram pressures. The shock system comprises an impact ram housing and an impact ram. The outer impact system is positioned above the press system with the lower side of the impact ram facing the upper side of the press ram. This example is an example of a single direction third generation machine.

In comparison, the WO 97/00751 percussion machine comprises only the outer impact system positioned above the the central unit and a stationary anvil positioned below the central unit.

In both machine configurations the central unit is positioned so that the lower punch is inserted into the moulding die through hole.

The main functionality steps of both machines are defined as pre-compaction, compression, retention and ejection. However, the execution of these step are performed fundamental differently and the deviations will be clarified.

The pre-compaction step with DFIER machine is performed by a simultaneous static pressure and a vibration of the powder. The static pressure compression is performed using the inner press system by an axial movement of the press ram. The vibration is performed by the vibration unit included in the inner system. The static pressure can therefore be controlled independently of the shock system. The percussion machine, WO 97/00751, performs the pre-compaction by vertical motion of the impact ram. The static pre-compaction pressure and sequence are therefore dependent on the pressure system required for the impact step and the sequence thereof, hence the pre-compaction must be terminated prior to shocking the powder.

Compaction with the DFIER machine is performed by keeping the static pressure on the press ram and hence retaining any strains in the working material and exact knowledge of the press ram position. The shock is generated by accelerating the impact ram under a constant actuation pressure impacting on the upper side of the press ram. The shock wave is transferred to the working material through the press ram and the upper punch while the pressure from the press ram is unchanged. Controlling the required impact energy is performed by the exact knowledge of the acceleration distance to the press ram. The impact ram is immediately retracted after the impact, while the static press still is contained. This will eliminate any re bouncing phenomenon, cracking or micro-fracture due to re bouncing internal shock waves.

The percussion machine WO 97/00751, performs the impact of the pre-compacted by accelerating the impact ram by a constant actuation impacting directly on the upper punch resting on the working material. However, the exact knowledge of the acceleration distance is lost when the static pressure is released and the whole chain of members, comprising the stationary anvil upper and lower punch and working material relaxes and hence expands. This means that the delivered shock energy to the working material is uncertain. Since there exists no static pressure on the working material after the impact, energy is lost in the compacted material through cracking and initiation of micro-fractures in the compacted material that may be caused by rebouncing internal shock waves.

The DFIER machine also retains the static pressure during the ejection step, which the percussion machine has not the functionality for it. This way, any strain that can cause cracks or micro fractures during ejection is eliminated. The static pressure is released when the material body completely outside the moulding die cavity and any internal waves have faded out.

In summary, a machine with an inner press system and an outer impact system is superior to a machine with an outer impact system alone for a machine configuration of single side action, to the benefit of the DFIER machine by the following:
the impact energy is more effectively transferred to the working material resulting in an increased material body density of a reduction in required shock energy
increased tool member life span with reduction in required shock energy
elimination of cracks and micro-fractures in the material body by a retained static pressure during and after impact and during the ejection.
Exact knowledge of delivered impact energy giving increased repetitive accuracy and more accurate component tolerances.

### EXAMPLE 2

This example illustrates the superiority of having an inner and an outer system compared to an outer system alone with a counter-acting ram configuration, compared to an outer impact system alone with a counter-acting impact ram configuration as described for the impact machine described in patent WO 02/22289.

The DFIER machine comprises an inner press system, and an outer impact system. The inner system comprises an upper press unit, a lower counter-acting press unit, a central unit and a vibrator system. The upper press unit comprises an upper ram housing, an upper press ram and an upper punch attached to the upper press ram. The lower press unit comprises a lower ram housing, a lower press ram and a lower punch attached to the lower press ram. The central unit is positioned between the upper and the lower press units, and carries a moulding die with a protruding hole. The upper and lower press ram housings are opened in both ends so that the press rams are protruding through the ram housings. The said press rams are acting vertically. The upper punch is positioned on the lower side of the upper press ram and the lower punch is positioned on the upper side of the lower press ram. The press systems are actuated and controlled by hydraulics by means of adjustable ram pressures.

The outer impact system comprises an upper impact unit and a lower counter-acting impact unit, each comprising an impact ram housing and an impact ram. The upper impact unit is positioned above the upper press unit with the lower side of the impact ram facing the upper side of the press ram, and the lower impact unit is positioned below the lower press unit with the upper side of the impact ram facing the lower side of the press ram.

In comparison, the said impact machine described in patent WO 02/22289, comprises only a system similar to the the outer impact system, with impact units positioned above and below the central unit acting in a counter-action direction. Additionally, the said impact machine is equipped with a system for positioning the working material in the moulding die cavity. Integrated in the outer system is also an upper and a lower impact body, which are used to hold and position the powder in the moulding die.

The main function steps of both machines are defined as filling of working material, pre-compaction, compression, and ejection. However, the execution of these steps are performed in a fundamentally different way and the deviations will be clarified.

Filling of working material is performed by raising the lower press ram to a position so that the lower punch is inserted in the moulding die through hole together creating a moulding die cavity. The powder is then filled by any automated means. The pre-compaction step with the DFIER machine is performed by a simultaneous static pressure and a vibration of the powder. The static pressure compaction is performed using the inner press units by an counter-acting axial movement of the press rams. The vibration is performed by the vibration unit included in the inner system. The static pressure can be controlled independently of the shock system.

The impact machine performs the filling of the working material in a separate filling station. An additional lower punch holder is therefore required to retain the lower punch and the working material contained in the moulding die cavity. The whole moulding die including the lower punch and the punch holder is thereafter moved and positioned in a processing station where the moulding die cavity is axially concentric with the upper punch. The pre-compaction is performed by counter-action motion of outer systems' upper and lower impact units, pushing impact bodies and the connected punches in a counter-acting pressure motion on the working material.

Compaction with the DFIER machine is performed by keeping the static pressure on the press ram and hence retaining any strains in the working material and gives exact knowledge of the press ram positions. The impact is generated by accelerating the impact rams at a constant actuation pressure, impacting the upper impact ram on the upper side of the upper press ram and impacting the lower impact ram on the lower side of the lower press ram. The shock wave is transferred to the working material by the press rams and the punches while the pressure from the press rams is unchanged. Controlling the required shock energy is performed by the exact knowledge of the acceleration distance to the press rams. The impact ram is immediately retracted after the shock, while the static press still is contained. This will eliminate any re-bouncing phenomenon, cracking or micro-fracture due to re-bouncing internal shock waves.

The impact machine described in patent WO 02/22289 performs the impacting of the pre-compacted material by accelerating the impact rams in a similar step as for the DFIER machine but the impact rams impacts on the impact bodies transmitting the shock wave by the punches to the working material.

After the shock process of the material body the DFIER machine retains the static pressure by the inner press rams until any internal shock wave has faded out. It is not described that the WO 02/22289 impact machine has such a function. This will relax the material and prevent initiation of cracks or micro-fractures occurring in the material body.

Ejection of the material body produced with the DFIER machine is performed by retaining the static pressure on the material body as described in Example 1, but the ejection could also be performed by an axial movement of the upper and lower press rams in the counter acting machine configuration. This retained pressure will also prevent occurrence of cracks and micro-fractures initiated by the friction between the moulding die and the material body during the ejection step. The impact machine performs the removal of the core rod and the ejection of the material body in separate steps. Hence the static pressure is removed and the ejection step is more prone to initiate cracks and micro-fractures.

In summary, a machine with an inner press system and an outer impact system with a counteraction configuration is superior a machine with a outer impact system alone of counter-acting configuration. The differences are summarised below to the benefit of the DFIER machine by the following:
a higher density of the pre-compacted material body due to the higher internal system static pressure and simultaneous vibration of the powder with the DFIER machine.
the impact energy is more effectively transferred to the working material due to the large pressure in combination with the impact, resulting in an increased material body density though a reduction in required impact energy.
decreased required impact energy due to the higher density of the pre-compacted material body.
increased tool member life span due to the reduction in required shock energy.
elimination of cracks and micro-fractures in the material body due to the retention of static pressure during and after shocking and during the ejection step.
A less complex machine. The impact machine WO 02/22289 requires multiple operation station, e.g. filling, ejection of core rod and ejection of material body.

### EXAMPLE 3

Comparing the single side action configuration with the counter acting machine configurations, the counter acting configuration is superior the single side configuration and the differences are summarised as:
large and costly foundations are obsolete due to the force vector balance between the counter acting systems
the energy fraction transferred to the material powder is much higher is the counter acting configuration due the the force balance and the two counter moving shock waves, whereas the shock wave from the single side configuration is transferred through the working material and out in the tool members
the tool life span is increased with a counter acting configuration, due to the reduced required shock energy, resulting in lower production costs.

1. An impact machine for producing a body by coalescence with desired shape of a workable material through shock (impact) action in an impact step, said impact machine comprising a machine stand, a dynamic outer system and a static inner system, with a central unit in between, characterized in that the machine, comprises an inner system (II), which comprises an upper press unit (V) with a ram (5) and a punch (8), a lower press unit (VI) which comprises a counter-acting ram (15) and a punch (13), and an outer system (III), comprising an upper impact ram unit (VIII) and a lower counter-acting impact ram unit (IX), each comprising mountable weights (24), that the central unit comprises one or more carriers (23), which contain and carry one or a plurality of identically equal, tool units, each one of which comprises a die (22) having a moulding die cavity (33) for the working material (26) that shall be formed, said carriers including at least one carrier which is stationary during the impact step and which contains at least one such tool unit; that motion devices are provided for indexing the carriers (23) in a horizontal plane for positioning the tool units in different function stations; that said function stations comprise a processing station (i) in which the die (22) is coaxial with the upper punch (8), and at least one more station which is either a station (ii) for service the moulding die cavity; that the kinetic energies of the movable masses during the press and impact steps, are essentially transferred to the working material in the moulding die cavity through at least one or more strokes and are so great that the working material flows out to fill all parts of the mould cavity, to form said body with desired shape; and, that the lower unit is provided in the region of the processing station, under the carrier, which is stationary during the impact step.

2. An impact machine according to claim 1, characterized in that said central unit includes a mechanical or a ultrasonic vibrator system to increase the flow of powder material in the mould resulting in a higher density of the body produced.

3. An impact machine according to claim 1 independently or together, characterized in that said inner system and outer system are independently equipped with one or more press AND/OR impact units creating side deformation of the working material through pre-compaction and compression respectively.

4. An impact machine according to claim 1, characterized in that said function stations comprise a station (i) for processing the working material in which the moulding die (22) is coaxial with the upper punch (8), said service station (ii).

5. An impact machine according to claim 1, characterized in that it comprises a carrier in the form of a carrier, and that a motion device is provided for sliding the shuttle in a linear stepwise forward and backward direction for positioning the tool unit in the various function stations.

6. An impact machine according to claim 4, characterized by devices for fixation of the carrier or carriers, when the carrier or carriers have been moved so that the tool units have adopted a position in a new function station.

7. An impact machine according to claim 1, characterized in that a lower (13) and an upper punch (8) are provided in the processing station (i), coaxial with the upper impact ram (1) and the lower impact ram (18) of the outer system are provided to simultaneously perform at least a single or multiple strokes with such a velocity against the upper press ram and against the lower press ram of the inner system, respectively, that those masses which move downwards, including the upper ram of the inner system, get a downwards directed velocity (VL), and those masses which move upwards, including the lower ram of the inner system, get an upwards directed velocity (v2), wherein the movable parts have such masses and the velocities are so high that the impulses of the downwards directed masses and of the upwards directed masses are essentially equally large, i.e. So that the following conditions will apply:
m₁v₁=m₂v₂
where m₁ is the total mass of downwards movable masses at the impact and m₂ is the total mass or the upwards movable masses at the impact, and that the kinetic energies of the movable masses, i. e.
$${E}_{1} = \frac{{m}_{1} {v}_{1}^{2}}{2} , and$$
$${E}_{2} = \frac{{m}_{2} {v}_{2}^{2}}{2} ,$$
respectively, are essentially transferred to the working material (27) in the moulding die cavity and are so great that the working material is plasticised and flows out to fill all parts of the moulding die cavity, when the punches are maximally brought together, for the formation of said body with desired shape; and that the die is essentially stationary during said stroke.

8. An impact machine according to claim 1, characterized in that said process station includes a laser to heat up powder during the filling step.

9. An impact machine according to claim 1, characterized in that said moulding die cavity has a controlled temperature through a heating and cooling devices (25) to create optimal conditions for forming of different material types.

10. An impact machine according to claim 1, characterized in that said moulding die cavity has a controlled atmospheric chamber (25), where gas can be evacuated out of or a protective gas can be injected into the moulding die cavity through an inlet and outlet nozzle to remove inclusions of air in the produced body.

11. An impact machine according to claim 1, characterized in that said inner system has an electrical discharge system with an alternating current and/or a direct current in any combination during either the pre-compaction step or the compression step or both.

12. An impact machine according to claim 1 for forming a body with at least one or more through holes AND/OR open cavities, characterized in that the functional units also comprise at least one or more core rods from the formed body.

13. An impact machine according to claim 1, characterized by producing bodies of particulate material, powder, solid or any combination thereof.

14. An impact machine according to claim 1, characterized in that the lower unit of the inner and outer systems comprise a counter impact device in the form of an anvil in said processing station (i), said anvil being stationary. that the inner system (II) comprises an upper press unit (V) with a ram (5) and a punch (8), and the outer system (III) comprises an upper impact ram unit (VIII), comprising mountable weights (24), with, for both the inner and outer systems in common, a stationary anvil.

15. An impact machine according to claim 1, characterized in that actuation of the inner and the outer systems could be at least one or more of hydraulic, spring, pneumatic and electrical controlled devices.
